(19) United States
(12) Patent Application Publication
(10) Pub. No.: US 2010/0296893 A1
(43) Pub. Date: Nov. 25, 2010

(54) NUT RETENTION DEVICE

(75) Inventor: Guy DUPIOL, Blagnac (FR)

Correspondence Address: Perman & Green, LLP, 99 Hawley Lane, Stratford, CT, 06614, US

(73) Assignee: AIRBUS OPERATIONS (SAS), Toulouse (FR)

(21) Appl. No.: 12/783,305

(22) Filed: May 19, 2010

(30) Foreign Application Priority Data
May 20, 2009 (FR) 09 53360

(51) Int. Cl. F16B 37/04

(52) U.S. Cl. 411/108

(57) ABSTRACT

A device for retaining nuts wherein it includes a lower part generally annular in shape and with a diameter intermediate in size between the diameter of a threaded rod to be inserted into the nut and the outside diameter of the nut, an intermediate part forming a support washer for a lower face of the nut and an upper part fitted with means of retaining the nut.

### CROSS-REFERENCE TO RELATED APPLICATIONS

This application claims priority to and the benefit of French Application No. 09 53360 filed on 20 May 2009, the disclosures of which are incorporated by reference in its entirety.

The aspects of the disclosed embodiments relate to a nut retention device to assist in assembling and fastening elements onto a supporting component.

### BACKGROUND

Many mechanical assemblies use nut and bolt means of fastening and it is known to provide nut retention devices on one of the components to be fastened together.

In particular, clip devices fitted with a fastening tab on a component and a nut retention part are known.

Such clips are cumbersome and require the component to be cut to significantly larger dimensions and with a more complex shape than a simple hole 10 to let the nut's complementary screw pass through.

### SUMMARY

The goal of the disclosed embodiments is to propose a nut retention device, small in size, easy to position within a screw-hole and providing secure retention of a nut on a component of an assembly to be secured by a nut and bolt.

To achieve this, the disclosed embodiments propose a nut retention device characterized in that it comprises a lower part generally annular in shape and with a diameter intermediate in size between the diameter of a threaded rod to be inserted into the nut and the outside diameter of the nut, an intermediate part forming a support washer for a lower face of the nut and an upper part fitted with means of retaining the nut.

### BRIEF DESCRIPTION OF THE DRAWINGS

Other features and advantages of the disclosed embodiments will become clear in reading the description of examples of realization of the disclosed embodiments that follows, with reference to the drawings which show;

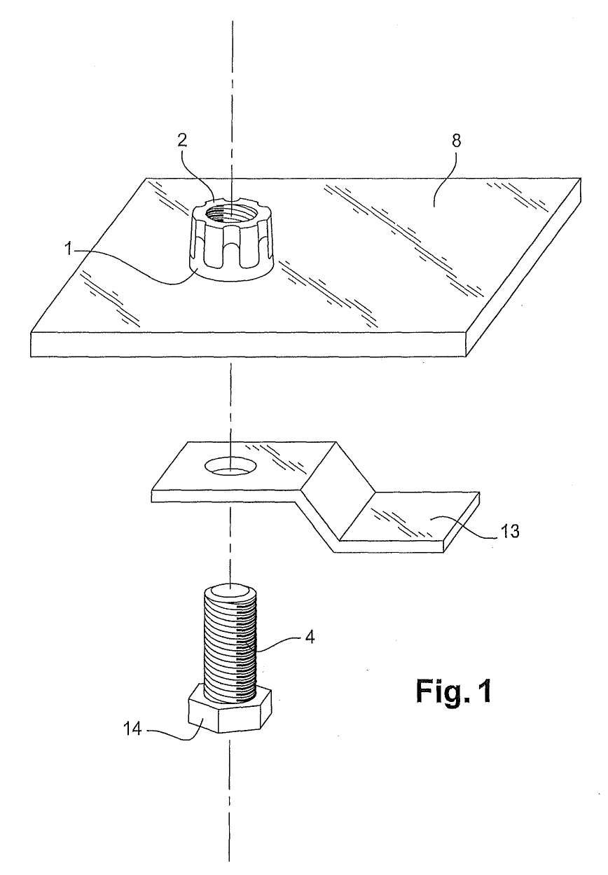

in FIG. 1: a perspective overview of a device of the disclosed embodiments mounted on a support plate;

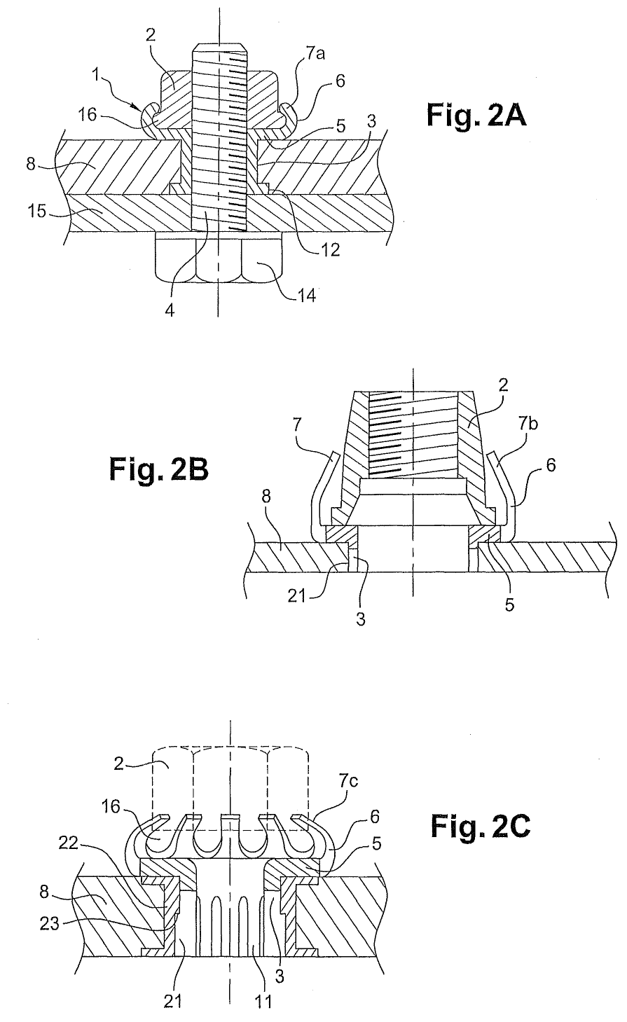

in FIGS. 2A, 2B and 2C: side cross-section views of variants of the device according to the disclosed embodiments;

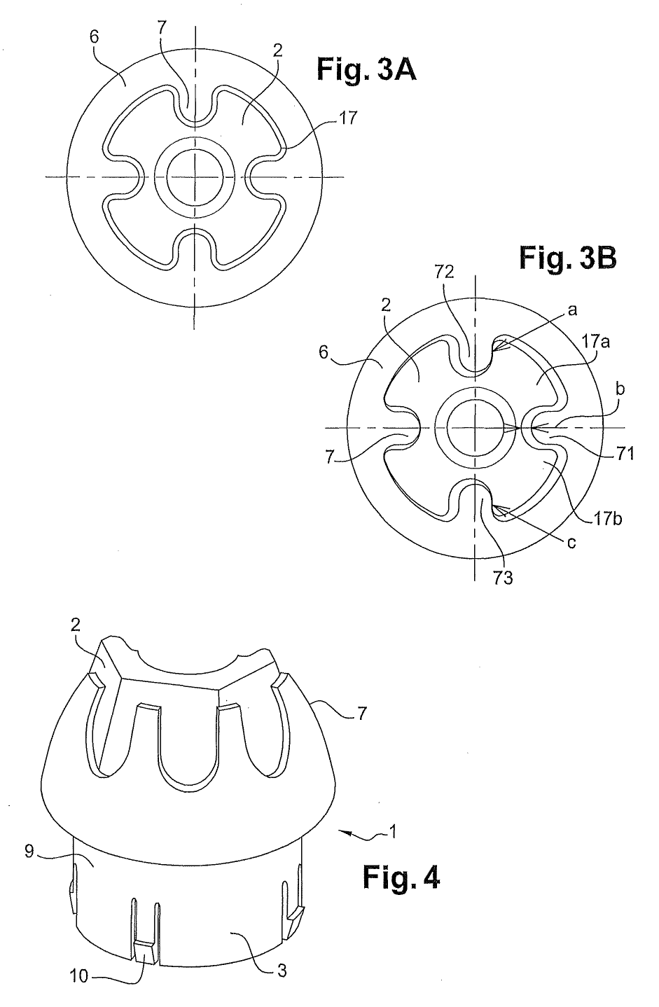

in FIGS. 3A and 3B: top views of a nut placed into a device according to the disclosed embodiments;

in FIG. 4: a perspective view of a device of the disclosed embodiments fitted with a nut;

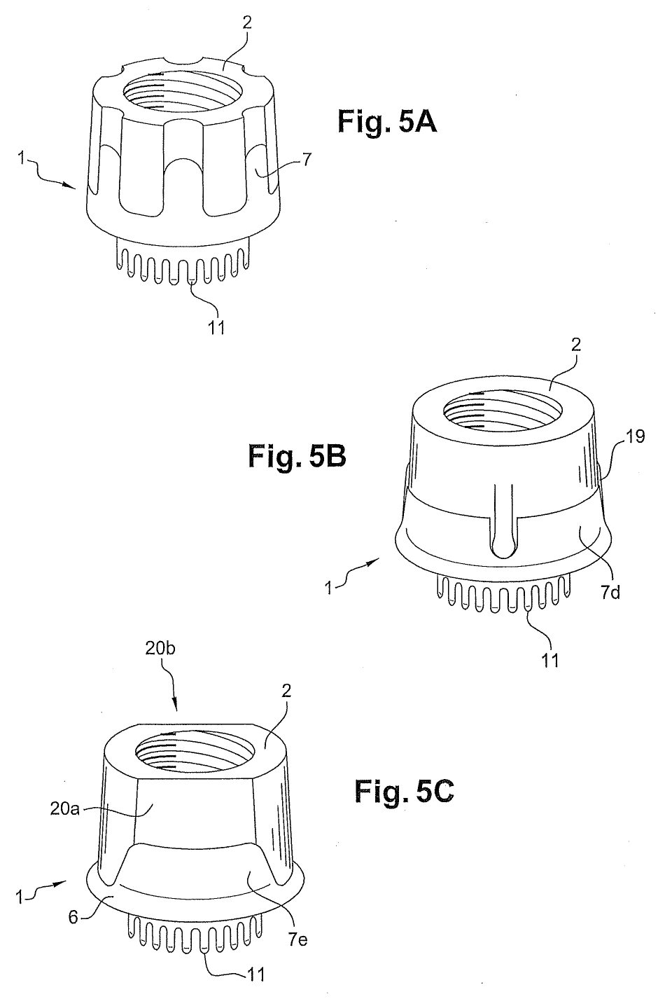

in FIGS. 5A to 5C: perspective views of variants of means of fastening the device of the disclosed embodiments on various types of nuts.

### DETAILED DESCRIPTION

The device 1 for retaining nuts 2 shown in FIG. 1 comprises, as shown in particular in FIG. 2A, a lower part 3 generally annular in shape and whose diameter is intermediate between the diameter of a threaded rod 4, which may be part of a screw 14, fitting into the nut and the outside diameter of nut 2.

Still with regard to FIG. 2A, it comprises an intermediate part 5, forming a support washer for a lower face of the nut and being applied onto a component 8 such as a support plate onto which device 1 retains nut 2.

Lastly, it comprises an upper part 6 fitted with means 7 of retaining nut 2 more particularly visible in FIG. 4, a perspective view of the device fitted with nut 2.

Back in FIG. 2A, the support washer forming intermediate part 5 connects to the lower part 3 at its inside edge and connects to upper part 6 by its outside edge.

The nut is retained on the support washer of intermediate part 5 by the upper part 6 of the device, the lower part of the device, fitting into a hole of the support formed by component 8, forms a ring fitting in the hole made in component 8 and receiving threaded rod 4 that screws into the nut.

To maintain the device in the hole, the ring comprises an outside surface fitted with gripping profiles 9 such as serrations or knurls, shown in FIG. 4.

Notably, the hole is advantageously pierced at a diameter corresponding to the outside diameter of the ring so that gripping profiles 9 bite into the material of the plate and provide retention of the device in the hole.

The dimensions of the hole can also be determined such that the ring is forcefully inserted into the hole so as to ensure a strong retention of the ring in the hole.

As a complement or as an alternative, the lower part, as shown in FIGS. 4, 2A to 2C, 4 and 5A, comprises a free lower edge fitted with gripping means 10, 11, 12, 21, to maintain the device in the hole traversing component 8.

In the example of FIGS. 2C and 5A, the gripping means comprise spring-loaded fingers 11 that may be fitted with a bulge 21.

In the example of FIG. 4, the gripping means comprise harpooning means 10, fastening on the rim of the hole opposite the edge supporting intermediate part 5 of the device.

In the example of FIG. 2A the gripping means comprise a shoulder 12 that may come from crimping the device on support component 8 and standing on the rim of the hole.

These various means ensure retention of the ring in its receiving hole as shown in FIG. 1 where we see the nut fitted with the device of the disclosed embodiments retained on a plate 8 to accept an accessory such as a fastening bracket 13 that will be attached to the plate by nut 2 and a bolt 14 fitted with a threaded rod 4.

Similarly in FIG. 2A, the device retains the nut in position until screw 14, that with nut 2 keep plates 8, 15 together, is tightened.

To retain the nut in the device, the upper part 6 is shaped as a crown, the means 7 of retaining the nut 2 being made of tabs to support the nut, curved in towards a central axis of the crown.

Several configurations are possible in the framework of the disclosed embodiments according to the type of nut.

According to FIG. 2A the nut comprises a lower flange 16 and the tabs 7a are bent over around the flange.

According to FIG. 2B, the nut is tapered in shape and tabs 7b are simply spring-loaded tabs folded over towards the nut.

In this case particularly, the nut can travel in a plane perpendicular to its axis of symmetry in the housing formed by the upper part of the device as shown in FIGS. 3A and 3B for a particular nut comprising lobes 17.

According to FIG. 3A, the nut is centered in the housing made up by lower part 6 fitted with tabs 7 and according to FIG. 3B, the nut is off-centered up to a maximum play “b” between two lobes 17a and 17b and a support for the side walls of lobes 17a and 17b at “a” and at “c” on tabs 72 and 73.

This play allows screwing the bolt and the nut when one or the other of these elements is slightly off-centered in relation to the hole in plate 8.

FIGS. 5A to 5C show alternative realizations of the upper part of the device for nuts of various shapes such as formed of alternating straight and semi-circular panes for FIG. 5A, smooth nut, fitted with anti-rotation fins 19 to be inserted between tabs 7d for FIG. 5B and nut fitted with two flat planes 20a, 20b linked by curved surfaces for FIG. 5C where the device 1 comprises two tabs 7e to be applied onto flat planes 20a, 20b of the nut.

It should be noted that the tabs grouped under general references 7 and 17 can, in addition, retain the nut in rotation, the device comprising amongst others means of gripping in component 8 functioning then in addition as a tightening tool thanks to the nut retention, to the gripping profiles 9 and to the friction surfaces of intermediate part 5 that is used in all cases as a support washer for the nut on component 8.

Back to lower part 3 of the system, FIG. 2B relates to an embodiment in which the lower part comprises a series of spring-loaded tabs fitted with an end bulge 21.

This is also the case in FIG. 2C for which the lower part 3 of the device is fixed in an insert 22 reinforcing component 8 at the fastening point formed by the device fitted with its nut.

Insert 22 comprises an internal shoulder 23 complementing end bulges 23 at the level of the spring-loaded fingers 11 forming the lower part of the device.

It will be further noted that in this example, the means of retaining the nut are curved over around a flange 16 of the nut and form a cage allowing the nut to rotate.

The disclosed embodiments are not limited to the examples shown and notably the intermediate part may itself comprise serrations, knurls or excrescences providing both friction and retention of the nut during tightening and when tightened, in the manner of a spring- or friction-type collar while remaining within the framework of the disclosed embodiments.

1. Device for retaining nuts comprising a lower part generally annular in shape and with a diameter intermediate in size between the diameter of a threaded rod to be inserted into the nut and the outside diameter of the nut, an intermediate part forming a support washer for a lower face of the nut and an upper part fitted with means of retaining the nut.

2. Nut retention device according to claim 1 in which the support washer forming the intermediate part connects to the lower part at its inside edge.

3. Nut retention device according to claim 1 in which the support washer forming the intermediate part connects to the upper part by its outside edge.

4. Nut retention device according to claim 1 in which the lower part forms a ring fitting in a hole made in a component and comprising an outside surface fitted with gripping profiles such as serrations or knurls.

5. Nut retention device according to claim 1 in which the lower part comprises a free lower edge fitted with gripping means in the hole.

6. Nut retention device according to claim 5 in which the gripping means comprise spring-loaded fingers.

7. Nut retention device according to claim 5 in which the gripping means comprise harpooning means.

8. Nut retention device according to claim 5 in which the gripping means comprise a shoulder or bulge.

9. Nut retention device according to claim 1 in which the upper part is shaped as a crown, the means of retaining the nut being constituted of tabs to support the nut, curved in towards a central axis of the crown.

10. Nut retention device according to claim 1 in which the intermediate part comprises serrations, knurls or excrescences providing both friction and retention of the nut during tightening and when tightened
